(19) United States
(12) Patent Application Publication
(10) Pub. No.: US 2011/0300033 A1
(43) Pub. Date: Dec. 8, 2011

(54) Pipette Holder and Applicator Apparatus

(75) Inventor: Peter D. Battisti, Alpharetta, GA (US)

(73) Assignee: CHEMENCE MEDICAL, INC., Alpharetta, GA (US)

(21) Appl. No.: 12/794,964

(22) Filed: Jun. 7, 2010

(51) Int. Cl. B01L 9/00

(52) U.S. Cl. 422/501; 422/564

(57) ABSTRACT

A two-piece holder and applicator for a squeezable pipette has a lower cylindrical body and a cap dimensioned to slide down over the body after the pipette has been inserted into the body. The cap has two diametrically-opposed vertical tabs that fit alongside the outer surface of the body, and each tab has an inwardly-facing button that is shaped to cooperate with a mating hole in opposing sides of the body. The buttons serve both to lock the cap onto the body and to transmit pressure applied by fingers on the outside of the tabs through the holes and against the walls of the pipette. Thus, when the tip of the pipette is punctured, the pipette can be squeezed using the tabs without touching the pipette. The small area of the buttons allow the user much greater control over the rate of dispensing of adhesive than if the entire area of opposing fingertips is used to squeeze the pipette.

### FIELD OF INVENTION

This invention is in the fields of packaging and dispensers.

### BACKGROUND OF INVENTION

A pipette, in the chemical arts, is a dispenser of a selected volume of liquids. The volume is typically determined drop-by-drop or by aliquot. Pipettes are usually tubular in structure and made of glass or plastic, and may either be pre-filled with a liquid or designed to be filled first and then emptied. They may be operated manually or automatically.

In the field of adhesives, pipettes are typically made of a plastic that is impervious to air and moisture, and of a generally cylindrical shape with flexible side walls. They are pre-filled with a liquid adhesive in a controlled environment to prevent the introduction of ambient substances into the tube that may cause the adhesive to cure, such as air and moisture. The tubes are sealed and may then be stored under whatever conditions of time and temperature as may be appropriate for the particular adhesive. When it is desired to dispense the liquid, one end of the tube is punctured and the sides of the tube is squeezed manually to push the liquid out of the tube drop by drop.

Some adhesives commonly packaged in pipettes, such as cyanoacrylates, are very unstable once the pipette is breached and cure almost instantly upon contact with air and/or moisture. Cyanoacrylates, specifically, are used to bond animal tissue, so when a pipette containing such adhesives is used manually, it is imperative that the user avoid contact of the adhesive with the fingers lest the fingers bond to each other or other surfaces. Even if latex gloves are used, the adhesive may either bond the glove surfaces to one another or dissolve the glove material and contact the skin anyway. Because many adhesive pipettes are small (typically less than two inches long and one-quarter inch thick) exceptional dexterity is required merely to apply the adhesive where it is needed, let alone keep it from running onto the fingertips or other extraneous surfaces. Further, because pipette-delivered cyanoacrylates are now commonly-used in medical procedures such as operations, allowing the adhesive to go where it is unwanted is not only inconvenient, it may have very injurious consequences.

### BRIEF DESCRIPTION OF THE INVENTION

The instant invention is a two-piece holder and applicator for a standard adhesive pipette having an approximately 1¾ inch-long cylindrical case. The lower piece of the applicator is a cylindrical body formed from a single piece of material such as plastic, having a flat base and a cylindrical shell with an open top. The internal diameter of the shell has an internal diameter capable of accepting a ⅜″ diameter pipette. Once a pipette is inserted into the body, the body and pipette may be stood up vertically on the base of the body. While the aforementioned dimensions are required for a standard pipette, it is understood that the scope of this invention includes other dimensions that are compatible with other cylindrical squeezable liquid dispensers.

The second, upper piece of the invention is a cap dimensioned to slide down over the body after a pipette is inserted into the body. The cap has two diametrically-opposed vertical tabs that fit alongside the outer surface of the body, and each tab has an inwardly-facing button that is shaped to cooperate with a mating hole in opposing sides of the body. The buttons serve both to lock the cap onto the body and to transmit pressure applied by fingers on the outside of the tabs through the holes and against the walls of the pipette. Thus, when the tip of the pipette is punctured, the pipette can be squeezed using the tabs without touching the pipette. The small area of the buttons allow the user much greater control over the rate of dispensing of adhesive than if the entire area of opposing fingertips is used to squeeze the pipette. The tabs are shaped to allow them to be pulled away from the body with a fingernail after use so as to release the cap from the body.

### OBJECTS OF THE INVENTION

One object of the invention is to provide a means for holding a pipette in a non-dispensing (vertical) orientation once it has been opened. Another is to permit the user to squeeze the pipette without touching it. Another is to provide these features with only two parts that may be formed with simple molds. Another object of the invention is to give the user greater control over the amount and location of applied adhesive.

### BRIEF DESCRIPTION OF THE DRAWINGS

FIG. 1 is a perspective view of the body of the first embodiment.

FIG. 2 is a perspective view of the cap of the first embodiment.

FIG. 3 is a perspective view of the first embodiment of the invention, fully assembled.

FIG. 4 is a bottom view of the body of the first embodiment.

FIG. 5 is a front view of the body of the first embodiment.

FIG. 6 is a top view of the body of the first embodiment.

FIG. 7 is a right side view of the body of the first embodiment.

FIG. 8 is a bottom view of the cap of the first embodiment.

FIG. 9 is a front view of the cap of the first embodiment.

FIG. 10 is a top view of the cap of the first embodiment.

FIG. 11 is a right side view of the cap of the first embodiment.

FIG. 12 is a front sectional view of the first embodiment as depicted in FIG. 3.

FIG. 13 is a front sectional view of the first embodiment at the first stage of assembly.

FIG. 14 is a front sectional view of the first embodiment at the second stage of assembly.

FIG. 15 is a front section view of the first embodiment at the third stage of assembly.

FIG. 16 is a front section view of a second embodiment at the third stage of assembly.

### DETAILED DESCRIPTION OF THE INVENTION

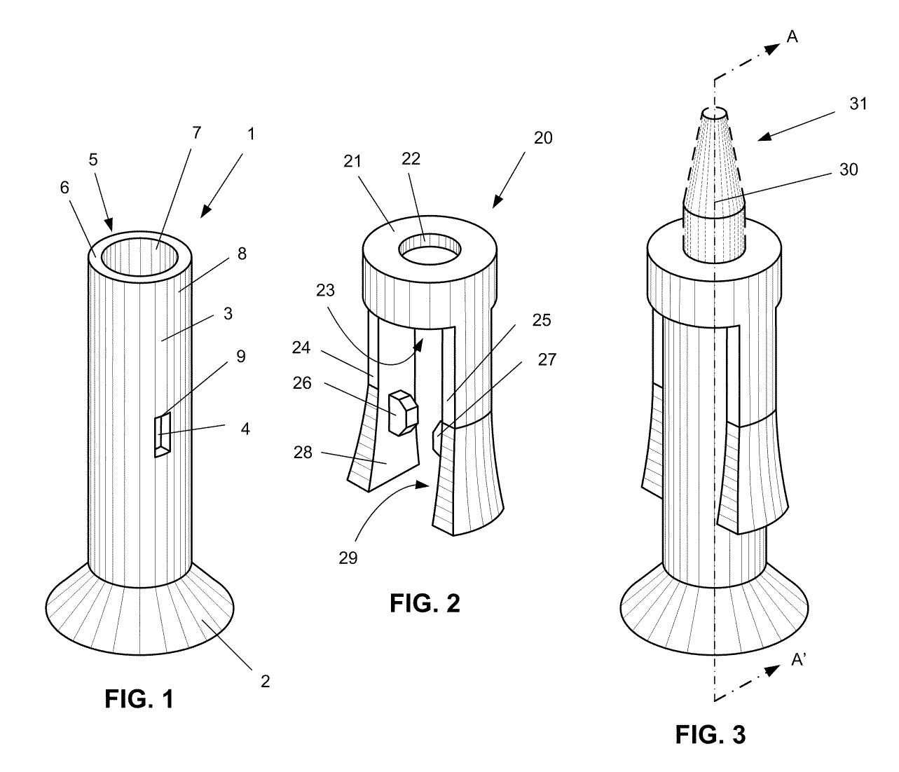

FIG. 1 is a perspective view of the body 1 of the first embodiment. It has a flared base 2, and an upright cylindrical shell 3 with an upper end 6 (an annulus in this embodiment) formed in one piece from, in this example, rigid plastic. The shell 3 has an inner surface 7 and an outer surface 8. Other rigid materials, such as metal, may be used. A substantially rectangular hole 4 (having an upper edge or lintel 9) extending all the way through the wall 5 of the shell 3, may be seen about midway up the outer surface 8. An identical hole (not visible in this view) is formed in the diametrically-opposite position on the outer surface 8.

FIG. 2 is a perspective view of the cap 20 of the first embodiment. It is formed in one piece from, in this example, resilient plastic. Other resilient materials, such as certain metals, may be used. It has a cylindrical collar 21 with an upper opening 22 and a lower opening 23, the lower opening dimensioned to fit slidingly over the shell 3. Shaped tabs (left, 24, and right, 25) depend vertically from opposite sides of the collar 21. Each tab 24 and 25 has a shaped button 26 and 27 fixed to the inner face 28 and 29 of the tabs 24 and 25, respectively.

FIG. 3 is a perspective view of the first embodiment of the invention, fully assembled. The tip 30 of a pipette 31 is shown in dashed lines representing environmental structure.

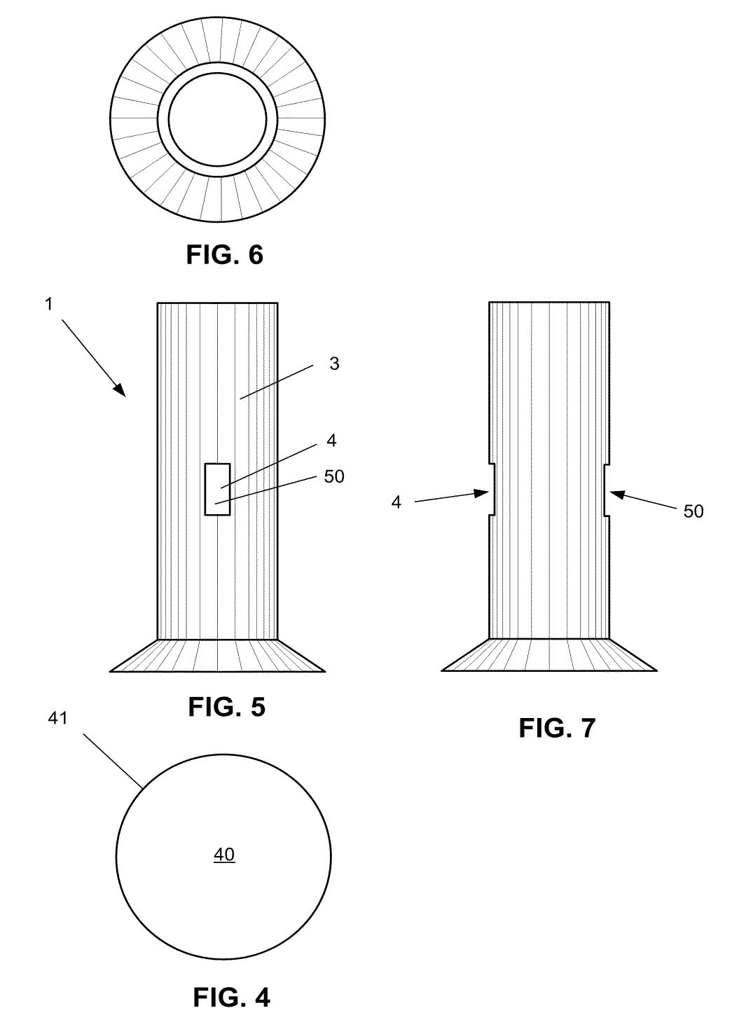

FIG. 4 is a bottom view of the body 1 of the first embodiment. The bottom surface 40 shown here is flat, but need not be, so long as, preferably, the edge 41 has coplanar points capable of supporting the cylindrical shell 3 in a substantially vertical position as shown.

FIG. 5 is a front view of the body 1 of the first embodiment showing the hole 4 and looking straight through shell 3 and through hole 50 on the other side.

FIG. 6 is a top view of the body 1 of the first embodiment.

FIG. 7 is a right side view of the body 1 of the first embodiment showing both holes 4 and 50.

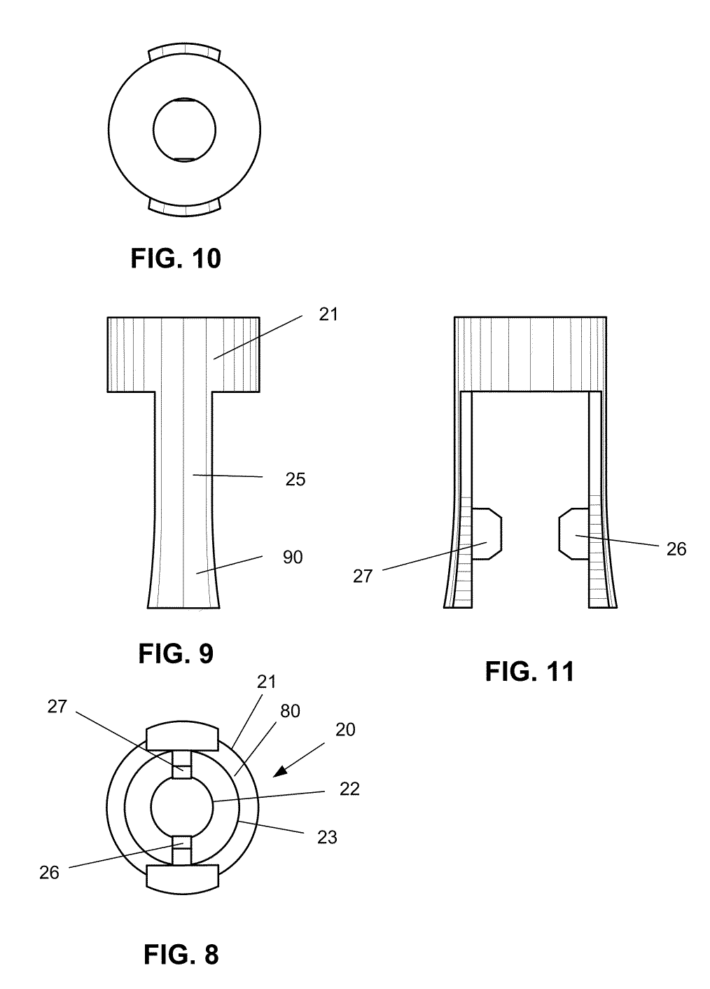

FIG. 8 is a bottom view of the cap 20 of the first embodiment, showing the underside 80 of the collar 21, the lower opening 23, and the upper opening 22. This view also shows the undersides of shaped buttons 26 and 27.

FIG. 9 is a front view of the cap 20 of the first embodiment showing the shaped tab 25 depending from the collar 21. Shaped tab 25 has an optional flared portion 90 near its lower end.

FIG. 10 is a top view of the cap of the first embodiment.

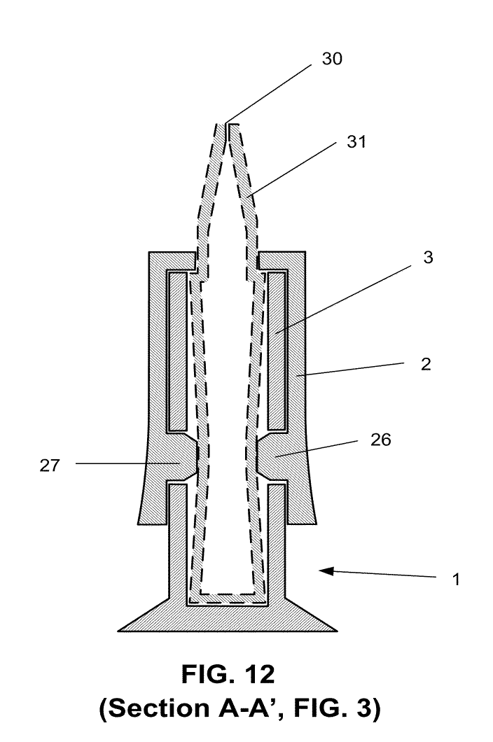

FIG. 11 is a right side view of the cap of the first embodiment, also showing shaped buttons 26 and 27.

FIG. 12 is a front sectional view of the first embodiment at section A-A′ of FIG. 3. As in FIG. 3, FIG. 12 It shows the pipette 31, shown in dashed lines representing environmental structure, in place within the cylindrical shell 3. The tip 30 of pipette 31 has been pierced, and the pipette itself has been squeezed by shaped buttons 26 and 27 causing the contents to be dispensed from the tip 30. The manner in which the pipette 31, the cap 20 and the body 1 cooperate during assembly and use are depicted in the following figures.

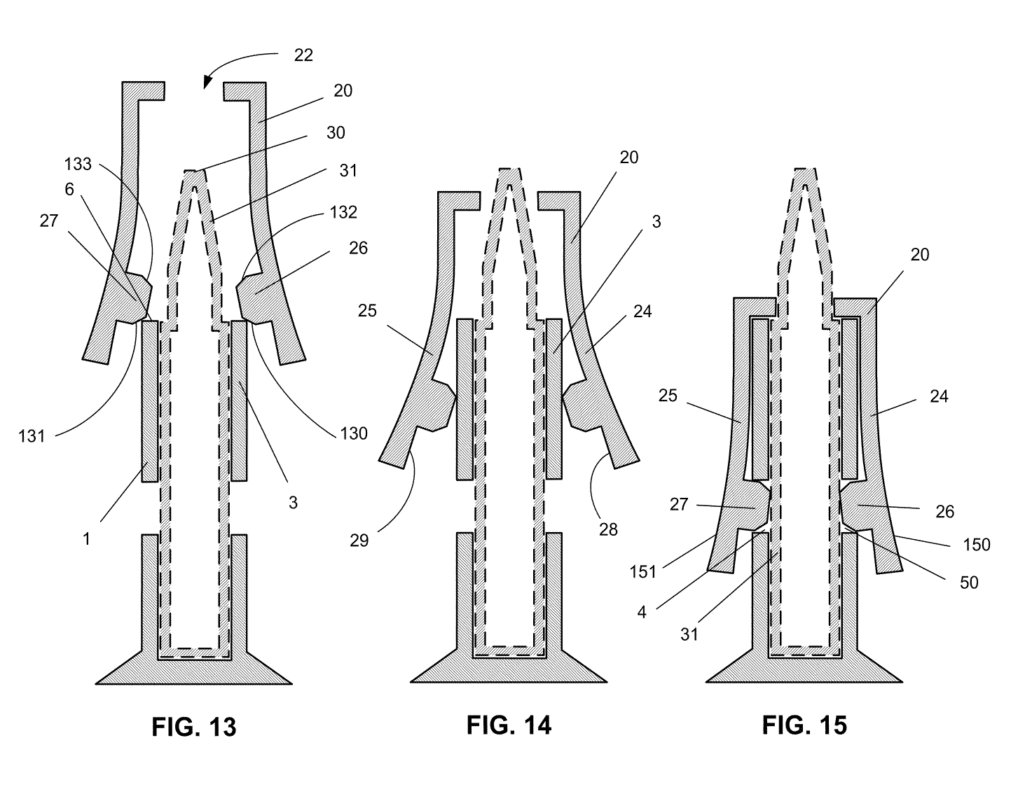

FIG. 13 is a front sectional view of the first embodiment at the first step of assembly. Initially, pipette 31 is inserted into body 1. Then, the upper opening 22 of cap 20 is placed over the tip 30 of pipette 31. In doing so, lower beveled corners 130 and 131 of buttons 26 and 27 come in contact with right and left edges 132 and 133, respectively, of shell 3.

FIG. 14 is a front sectional view of the first embodiment at the second step of assembly. Here, inner faces 28 and 29 of tabs 24 and 25 have been pried apart with fingertips to allow cap 20 to slide farther down shell 3.

FIG. 15 is a front sectional view of the first embodiment at the third step of assembly, before the pipette 31 is pierced and squeezed. Here, the cap 20 has been pushed as far down as it will go. The resilience of the tabs 24 and 25 has snapped the buttons 26 and 27 into the holes 50 and 4 in the shell 3. Finger pressure on the outer tab surfaces 150 and 151 now will cause the buttons 26 and 27 to press farther inward against the pipette 31, as shown in FIG. 12, thereby causing adhesive to be dispensed.

To remove the pipette 31 from the invention, the inner faces 28 and 29 of tabs 24 and 25 may be pried apart with fingertips or fingernails to release buttons 26 and 27 from holes 50 and 4, thereby permitting cap 20 to be slid upward and off of base 1.

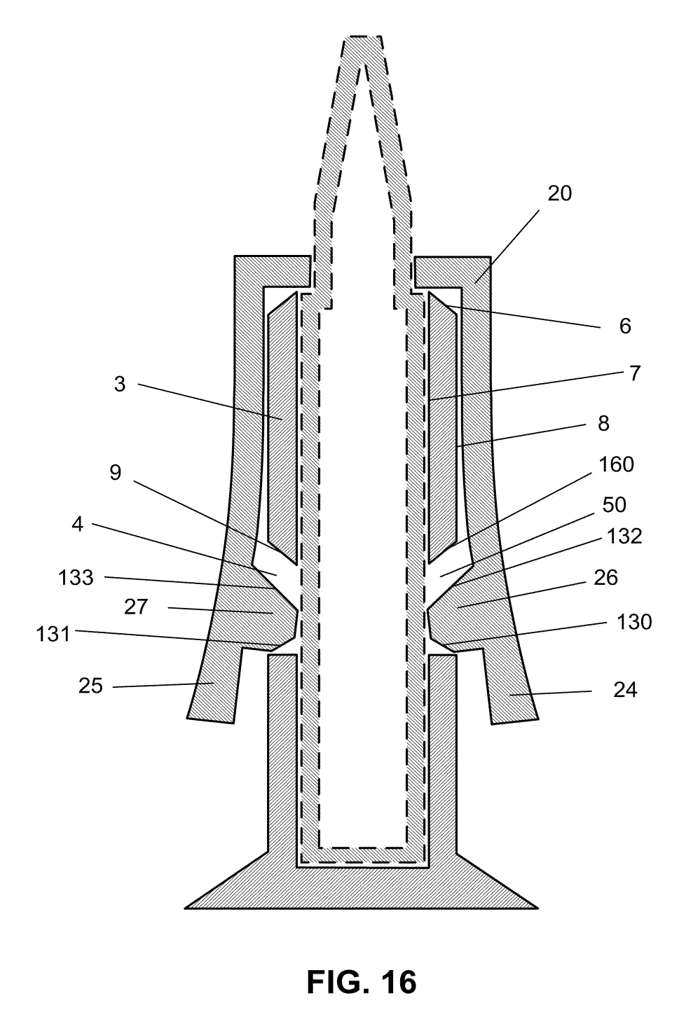

FIG. 16 is a front section view of a second embodiment at the third stage of assembly. This embodiment differs from the first in the shapes of upper end 6 of shell 3, and/or the shapes of buttons 26 and 27, and/or the shapes of holes 4 and 50 have been altered to facilitate assembly and/or disassembly of cap 20 from shell 3. Specifically, to aid in starting cap 20 onto shell 3, the upper end 6 of the shell 3 has been beveled downward from inner surface 7 to outer surface 8 to produce a conical surface at upper end 6. This enables the lower beveled corners 130 and 131 of buttons 26 and 27 to engage the upper end 6 more easily in such as way as to push the lower beveled corners 130 and 131 outwardly and over outer surface 8 without first having to pull the shaped tabs 24 and 25 outwardly with a finger or fingernail.

Similarly, the upper beveled corners 132 and 133 of buttons 26 and 27 can be extended (compare the corners here with their shapes in FIG. 13) and/or the lintels 9 and 160 of holes 4 and 50, respectively, can be sloped upwardly from inner surface 7 to outer surface 8, so that when the cap 20 is pulled upwardly to remove it from the shell 3, the buttons 26 and 27 are pushed outwardly over surface 8 without first having to pull the shaped tabs 24 and 25 outwardly with a finger or fingernail.

1. A pipette holder and applicator apparatus, comprising:
a body comprising an elongate, substantially cylindrical shell, and a base;
the shell having an open upper end, a cylindrical inner surface of a first diameter and a coaxial outer surface of a second diameter, the thickness of the shell being about one-half the difference between the second diameter and the first diameter, and a first plurality of holes extending from the outer surface through to the inner surface, the holes disposed at about equal angular distances from each other around the centerline of the shell and at a first vertical distance from the open upper end;
a cap comprising a collar, the collar having a lower surface and an upper surface;
the lower surface having a substantially vertical cylindrical first bore of approximately the second diameter so that the first bore slidingly fits over the outer surface of the shell;
the upper surface having a substantially vertical cylindrical second bore of a third diameter extending from the upper surface through to the first bore;
the second bore being coaxial to the first bore;
the cap further comprising a plurality, equal to the first plurality, of elongate, resilient tabs depending downwardly from the lower surface, and disposed at about equal angular distances from each other around the periphery of the lower surface;
the tabs each having
an inner face substantially facing the centerline of the second bore;
a button disposed inwardly on the inner face at approximately the first vertical distance from the lower surface;
each button being shaped to pass through each hole and having an inner edge spaced a horizontal distance inward from each inner face greater than the thickness of the shell;
the resiliency of each tab creating a bias force on each button towards the centerline of the first bore when the cap is placed on the body by sliding the first bore downward over the outer surface of the shell, the bias force being at least partially relieved when the inner edge of a button enters a hole, and the bias force being re-created when upward movement of the cap causes a button to begin to emerge from a hole.

2. The apparatus of claim 1, in which:
said inner face of each of said tabs is shaped so that the push of a finger can be applied to said inner face outwardly away from said outer surface to release said buttons from said holes.

3. The apparatus of claim 1, in which:
the upper end of said shell is beveled downward from said inner surface to said outer surface; and
each of said holes has a lintel beveled upward from said inner surface to said outer surface.

4. The apparatus of claim 1, in which:
said button has a shape that will cause said button to move horizontally against said bias away from said centerline upon first contact with said upper end when said cap is moved manually downward toward said body, and upon contact with the edge of said hole when said cap is moved upward.

5. The apparatus of claim 4, in which:
said shape is defined, at least, by the cross-section of said button, in a plane passing through said centerline and said button, having
an outer edge at the intersection of said button with said inner surface of said tab;
said inner edge;
an upper edge connecting the top of the outer edge with the top of said inner edge;
a lower edge connecting the bottom of the outer edge with the bottom of the inner edge;
the outer edge being longer than the inner edge;
the upper edge sloping downwardly along at least a portion of its length from the outer edge to said inner edge; and
the lower edge sloping upwardly along at least a portion of its length from the outer edge to said inner edge.

6. A holder and applicator apparatus for a pipette, the pipette containing liquid and having a vertical cylindrical container portion, the container portion having a container height and a container diameter, and a tapered applicator connected to the top of the container portion by a neck having a neck diameter; comprising:
a substantially vertical cylindrical body comprising
a vertical cylindrical cavity having an open upper end, the cavity about equal to the container height, and the cavity diameter about equal to the container diameter so that the container portion of the pipette can slide essentially fully into the cavity;
a cylindrical outer body wall concentric with the cavity and having a body wall diameter;
the wall thickness being one-half the difference between the body wall diameter and the cavity diameter;
a substantially horizontal base supporting the apparatus free-standing;
two holes through the outer body wall to the cavity, disposed diametrically to each other about the cylindrical body wall and located vertically a first distance below the upper end;
a cap comprising
an upper surface;
a perimeter;
a substantially flat, substantially horizontal lower surface with a cylindrical vertical bore hole extending upwardly part way through the cap toward the upper surface;
the bore hole having a diameter slightly larger than the body wall diameter and slidingly fitted over the body wall;
an applicator neck hole concentric with the bore hole and extending upwardly from the top of the bore hole through to the upper surface;
two vertically elongate tabs each having an upper end, a lower end, a substantially vertical inner surface, and an outer surface;
each upper end being fixed to the lower surface of the cap so that the tabs are diametrically opposed to each other about the cylindrical body wall;
each inner surface being substantially parallel to the other and tangential to the cylindrical body wall;
two buttons each having a vertically-disposed base affixed to the two vertical inner surfaces at the first distance from the lower surface;
the base of each button being shaped to fit within each hole;
each button protruding by a second distance from each vertical inner surface through each hole toward the center of the cavity;
the second distance being greater than the wall thickness;
so that when a pipette is secured within the cavity and the tip of the applicator is pierced, compression of the outer surfaces of the tabs towards each other will cause the buttons to squeeze the vertical cylindrical container portion of the pipette and force liquid to flow from the pipette.

7. A holder and applicator apparatus for a pipette, the pipette having a vertical cylindrical container portion, the container portion having resilient walls, and an applicator connected to the top of the container portion by a neck; comprising:
a substantially vertical body with an open-topped cylindrical cavity,
the cavity being defined by a wall having a thickness and an outer surface;
the body further comprising at least one pair of holes on opposite sides of the body through the wall into the cavity;
a cap fitting in sliding engagement with the outer surface and
having a neck hole fitting over the neck of the pipette;
at least one pair of buttons
connected to, and being positioned below, the cap so as to enter the at least one pair of holes when the cap is fitted as far down on the open top as it will go;
each button having a horizontal length extending through each hole and into the cavity beyond the container diameter;
means for biasing the at least one pair of buttons towards each other into the holes substantially without compressing the resilient walls;
means for applying manual pressure against the at least one pair of buttons to compress the resilient walls; and
means for manually overcoming the bias so that the at least one pair of buttons will move away from each other out of the at least one pair of holes.

8. The apparatus of claim 7, further comprising:
means for manually overcoming the bias so that said at least one pair of buttons will move away from each other upon contacting said open top.

9. The apparatus of claim 8, in which:
said means for manually overcoming the bias so that said at least on pair of buttons will move away from each other upon contacting said open top comprises
lower surfaces on each button that slope upwardly toward the opposing button
that are positioned to contact opposite sides of said outer surface of said open top when said cap is moved towards sliding engagement with said open top.

10. The apparatus of claim 9, in which:
said means for manually overcoming the bias so that the at least one pair of buttons will move away from each other out of the at least one pair of holes is one or both options taken from the list of:
a) upper surfaces on each button that slope downwardly toward the opposing button that are positioned to contact said outer edge of each hole when said cap is moved upwardly to remove said cap from said outer surface of said open top; and
b) flanges affixed to each button by which opposing finger pressure away from said body may be applied to each button.

10. The apparatus of claim 7, in which:
said means for biasing said at least one pair of buttons comprises at least one pair of resilient vertical tabs on opposite sides of said body connecting said at least one pair of buttons to said cap;
each vertical tab having an inside surface facing the body and an outside surface facing away from the body;
each button being affixed to the inside surface; and
said means for applying manual pressure upon said at least one pair of buttons towards the body comprises finger pad surfaces placed on the outside surfaces of the at least one pair of vertical tabs.
